(19) United States
(12) Patent Application Publication
(10) Pub. No.: US 2010/0252288 A1
(43) Pub. Date: Oct. 7, 2010

(54) PNEUMATIC TOOL HAVING A ROTATIONAL SPEED DETECTION DEVICE

(76) Inventor: Chin-Ho HSU, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/419,529

(22) Filed: Apr. 7, 2009

(51) Int. Cl. B25B 23/145; B23Q 5/06; G05D 7/00

(52) U.S. Cl. 173/20; 173/218; 700/282

(57) ABSTRACT

A pneumatic tool having a rotational speed detection device includes a light blocking member mounted on a spindle and a sensor corresponding in position to the light blocking member. The sensor is electrically connected to a counter module. A display is to show a rotational speed. When the spindle starts to spin, the light blocking member will lock the light path of the sensor and the counter module will record the number of the times to count the rotational speed to be showed on the display, thus the user may read the rotational speed and make an adjustment on an air flow control module as necessary till the rotational speed reaches the desired speed.

### BACKGROUND OF THE INVENTION

1. Field of the Invention

The present invention relates to a pneumatic tool having a rotational speed detection device, and more particularly to one having a light blocking member, a sensor, a counter module to calculate the rotational speed, a display to show the rotational speed, and an air flow control module to adjust the rotational speed of a spindle as desired.

2. Description of the Prior Art

Taiwanese Patent No. M308838 titled “A Pen-like pneumatic tool equipped with hand adjusting air flow controller” corn prises an air control mechanism to adjust the air flow volume, a manual air flow control knob. The manual air flow control knob is mounted on the surface of the pneumatic tool, and has a protruding block for the user to grab and turn the knob to adjust air flow volume. However, this design can do an adjustment, but cannot display the rotational speed.

### SUMMARY OF THE INVENTION

According to the present invention, there is provided a pneumatic tool having a rotational speed detection device, comprising:

a main body having a first chamber and a second chamber therein;

an air flow control module inserted into the second chamber of the main body;

a rotor disposed in the first chamber of the main body;

a spindle having a first end connected to the rotor and a second end connected to a connector, the spindle being covered with a sleeve, the sleeve being secured to the main body, and characterized by:

the spindle comprising a light blocking member thereon, the sleeve comprising a sensor corresponding in position to the light blocking member, a counter module and a display, the sensor being electrically connected to the counter module, the display being adapted to show a rotational speed.

Preferably, the main body further comprises a partition between the first chamber and the second chamber and an intake sleeve, the partition being formed with a through hole for interconnecting the first chamber with the second chamber, the intake sleeve being inserted into the second chamber, the rotor being disposed in the first chamber, the air flow control module being inserted into the second chamber and located between the partition and the intake sleeve.

Preferably, the air flow control module comprises an adjusting valve and an intake valve, the adjusting valve and the intake valve being inserted into the second chamber from respective sides of the main body and located between the partition and the intake sleeve.

Preferably, the pneumatic tool having a rotational speed detection device further comprises an initiating element, the initiating element being pivotally connected to an outer wall of the main body at an angle and holding against the intake valve of the air flow control module.

Preferably, the rotor comprises at least a driven member on a side wall thereof.

Preferably, the sleeve has a first end secured to the main body with a first fastener and a second end provided with a lid, the connector extending out the lid, the sleeve further having a trough on an outer wall thereof and an aperture in the trough, the counter module being secured in the trough with a second fastener, the sensor being inserted through the aperture and located in the sleeve, the display being exposed on the sleeve.

Preferably, the sleeve comprises a first connecting portion and a second connecting portion, the first connecting portion and the second connecting portion being secured together with a third fastener, the trough being disposed on the first connecting portion.

Preferably, the display comprises a display board, a switch, and a protecting lid, the display board and the switch being electrically connected to the counter module, the protecting lid being adapted to cover the counter module.

Preferably, the connector comprises a clip and a fixture, the clip being inserted into the spindle, the fixture being fitted onto the clip and secured to the spindle.

Preferably, the sensor is in a reverse U-like shape and the light blocking member is in a circular shape with at least a light blocking tab extending from a rim thereof.

Preferably, the spindle has a blocking portion corresponding in position to the sensor, the light blocking member having a first side holding against the blocking portion, the spindle further comprising a locating ring holding against a second side of the light blocking member.

Preferably, the locating device is a C-shaped ring.

It is the primary objective of the present invention to provide a pneumatic tool having a rotational speed detection device, which uses the light blocking member to block light passing through the sensor. The counter module calculates the light being blocked and the display shows the result for the user to monitor the air flow control module and to make an adjustment as necessary.

It is another objective of the present invention to provide a pneumatic tool having a rotational speed detection device, which secures the counter module in the trough. The sensor is inserted through the aperture in the trough and located in the sleeve. The display is exposed on the sleeve for the user to acquire the rotational speed.

### BRIEF DESCRIPTION OF THE DRAWINGS

FIG. 1 is an exploded view of the present invention;

FIG. 2 is a perspective view of the present invention;

FIG. 3 is a cross-sectional view of the present invention;

FIG. 4 is a cross-sectional view of the present invention in operation;

FIG. 5 is a cross-sectional view showing a light blocking member and a sensor of the present invention; and

FIG. 6 is a perspective view of the present invention with a display showing the rotational speed.

### DETAILED DESCRIPTION OF THE PREFERRED EMBODIMENT

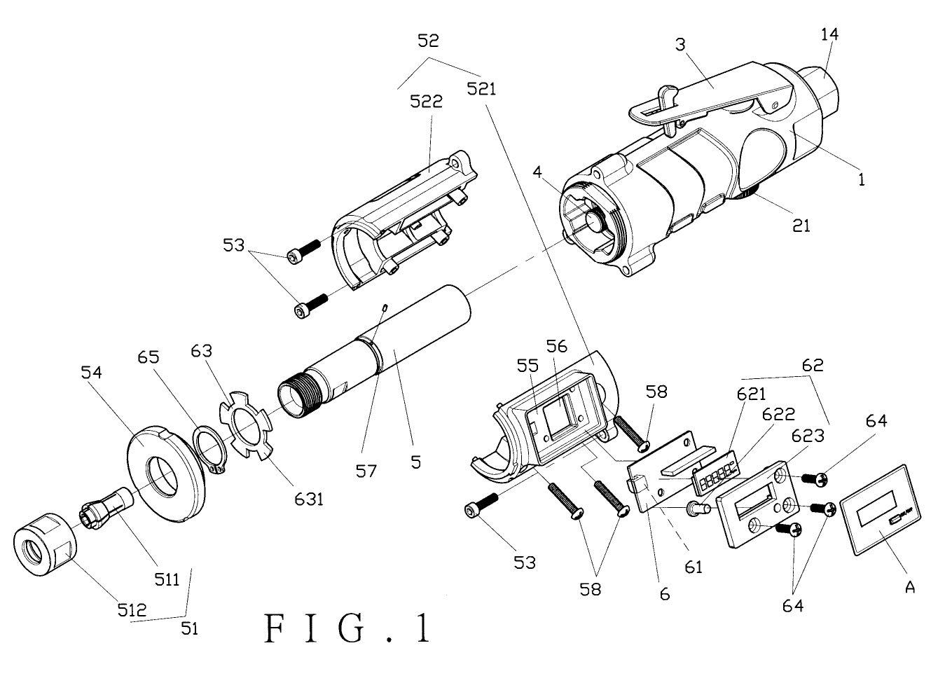

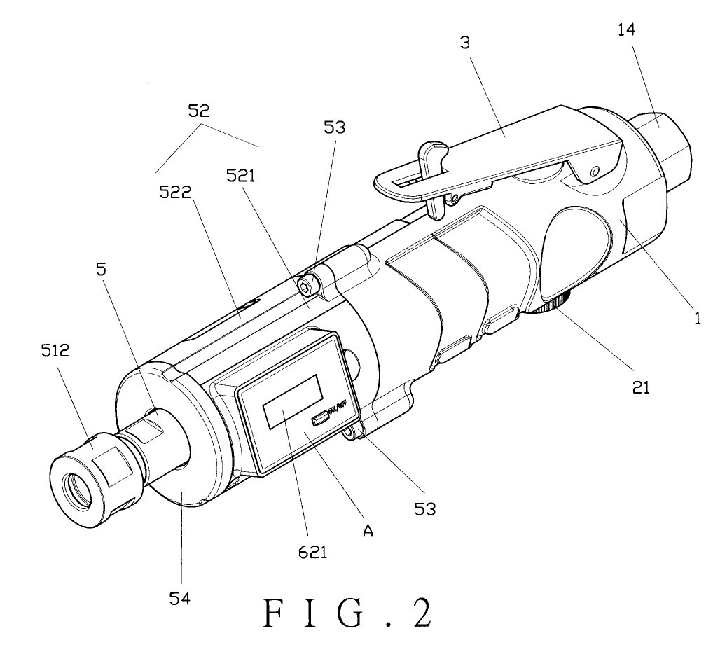

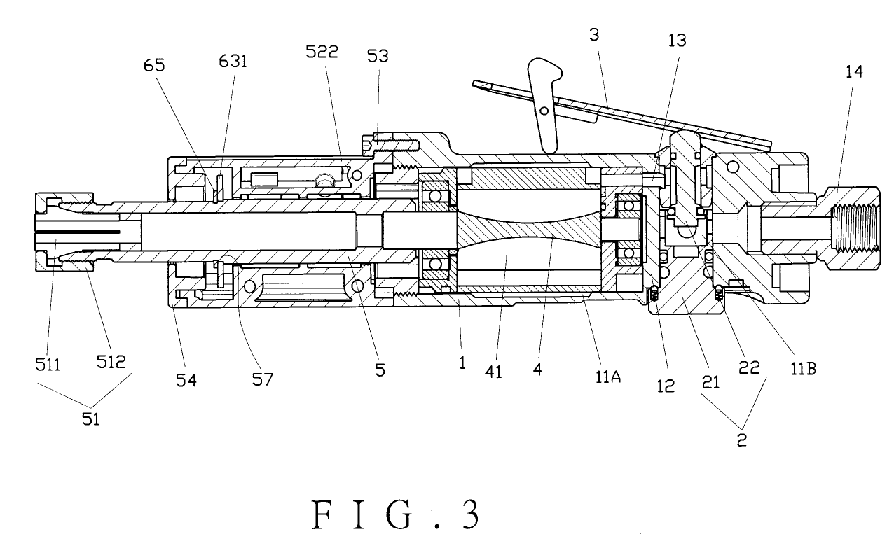

A pneumatic tool having a rotational speed detection device, as shown in FIGS. 1, 2 and 3, comprises a main body 1, an air flow control module 2, an initiating element 3, a rotor 4, and a spindle 5.

The main body 1 comprises a first chamber 11A, a second chamber 11B, a partition 12 between the first chamber 11A and the second chamber 11B, and an intake sleeve 14. The partition 12 is formed with a through hole 13 for interconnecting the first chamber 11A with the second chamber 11B. The intake sleeve 14 is inserted into the second chamber 11B.

The air flow control module 2 comprises an adjusting valve 21 and an intake valve 22. Both the adjusting valve 21 and the intake valve 22 are inserted into the second chamber 11B from respective sides of the main body 1 and located between the partition 12 and the intake sleeve 14.

The initiating element 3 is pivotally connected to the main body 1 at an angle and holds against the intake valve 22 of the air flow control module 2.

The rotor 4 is disposed in the first chamber 11A of the main body 1. The rotor 4 comprises at least a driven member 41 on a side wall thereof.

The spindle 5 has a first end connected to the rotor 4 and a second end connected to a connector 51. The connector 51 comprises a clip 511 and a fixture 512. The clip 511 is inserted into the spindle 5. The fixture 512 is fitted onto the clip 511 and secured to the spindle 5. The spindle 5 is covered with a sleeve 52. A first end of the sleeve 52 is secured to the main body 1 with a first fastener 53. A second end of the sleeve 52 is covered with a lid 54. The connector 51 extends out the lid 54. The sleeve 52 is formed with a trough 55 on an outer wall thereof and an aperture 56 in the trough 55. The spindle 5 comprises a blocking portion 57. In this embodiment, the sleeve 52 comprises a first connecting portion 521 and a second connecting portion 522. The first connecting portion 521 and the second connecting portion 522 are secured with a third fastener 58. The trough 55 is disposed on the first connecting portion 521. The sleeve 52 composed of the first connecting portion 521 and the second connecting portion 522 is detachable for maintenance.

The spindle 5 further comprises a light blocking member 63 thereon. The light blocking member 63 has a first side holding against the blocking portion 57 of the spindle 5 and a second side holding against a locating member 65 provided on the spindle 5. The locating member 65 may be a C-shaped ring. A sensor 61 is provided in the sleeve 52 and corresponds in position to the light blocking member 63. The sensor 6 is electrically connected to a counter module 6. A display 62 is provided to show the result from the counter module 6. The display 62 comprises a display board 621, a switch 622 and a protection lid 623. The display board 621 and the switch 622 are electrically connected to the counter module 6, and the protection lid 623 covers the counter module 6. The protection lid 63 is provided with a film A with instruction printed thereon. The counter module 6 is secured in the trough 55 of the sleeve 52 with a second fastener 64. The sensor 61 is inserted through the aperture 56 and located in the sleeve 52. The display 62 is exposed on the sleeve 52. The sensor 61 is in a reverse U-like shape. The light blocking member 63 is in a circular shape with a plurality of light blocking tab 631 extending from a rim of the light blocking member 63.

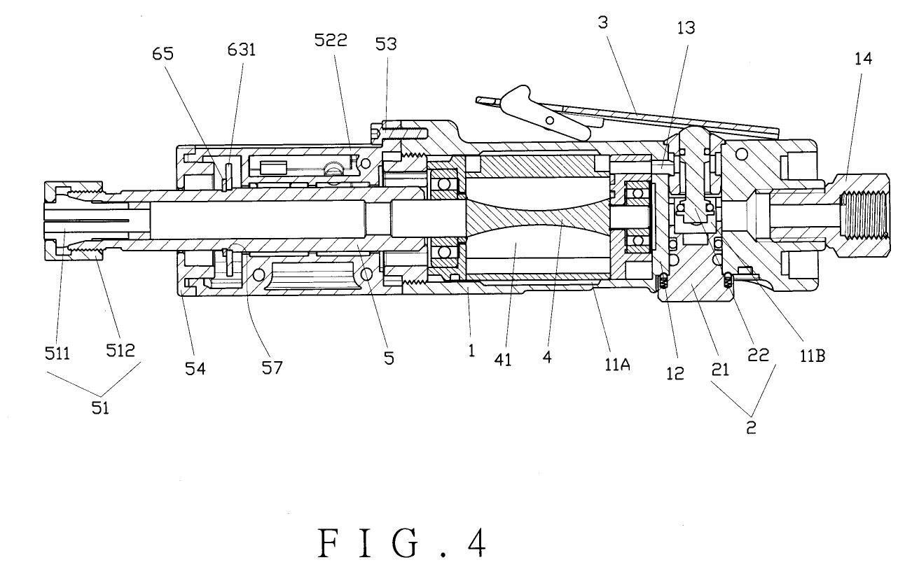

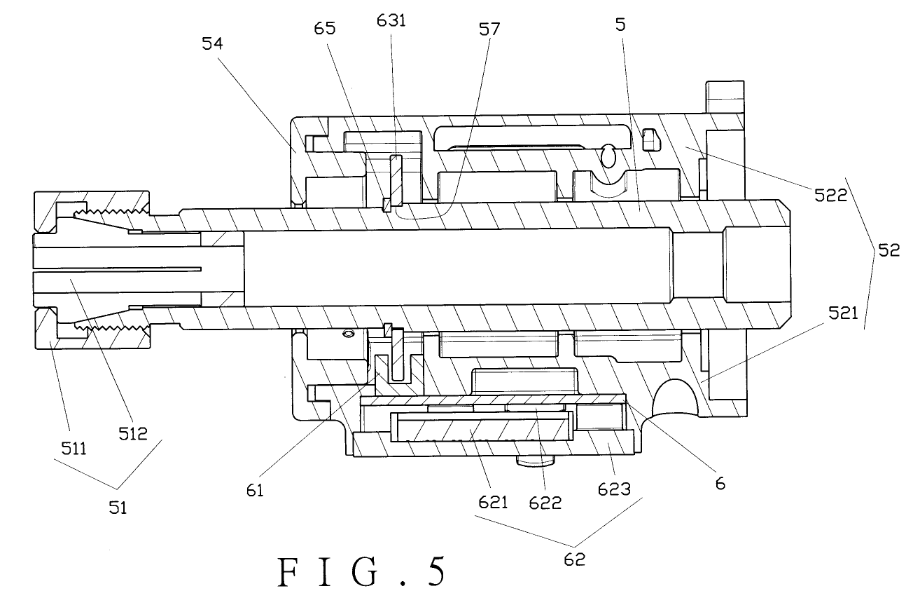

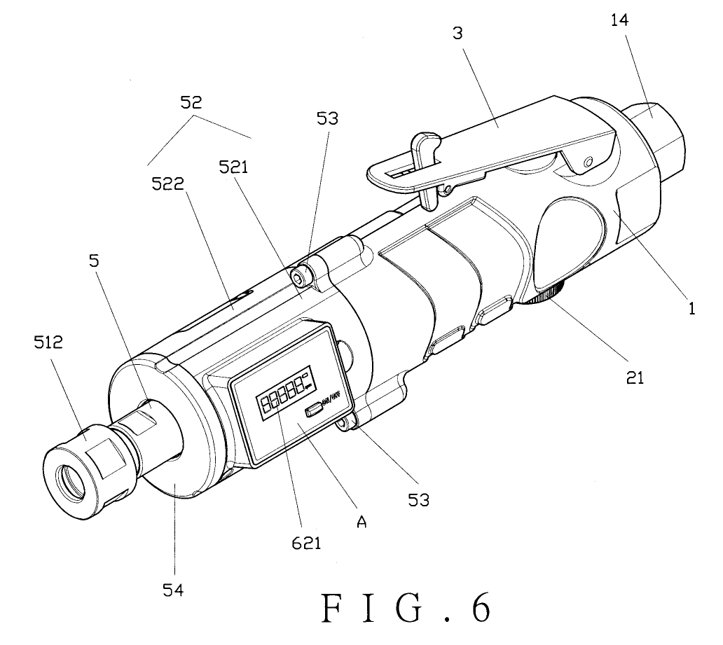

To operate the present invention, as shown in FIGS. 4, 5 and 6, a workpiece, such as a screwdriver, is inserted into the clip 511 of the connector 51 for fastening or loosening a screw. The switch 622 of the display 62 is turned on and the initiating element 3 is pressed to push the intake valve 22 so that the intake valve 22 is opened to flow air through the intake sleeve 14 into the adjusting valve 21, and then into the intake valve 22, the through hole 13 of the partition 12 and the first chamber 11A. The air drives the driven member 41 of the rotator 4 to rotate, which then links the rotor 4 to rotate simultaneously. Because the rotor 4 is connected with one end of the spindle 5, the spindle 5 is also linked to rotate, and the light blocking member 63 on the spindle 5 will also be linked to rotate as well. The light blocking tabs 631 of the light blocking member 63 will block the light path of two side walls of the reverse U-shaped the sensor 61, and the counter module 6 will record the number of the times to count the rotational speed. The rotational speed will be presented on the display board 621 of the display 62. The reading from the display 62 provides a user to decide whether to do an adjustment of the rotational speed. When the rotational speed is too slow, the user may adjust the adjusting valve 21 to increase air volume applied to the driven members 41, and the rotational speed of the rotor 4 and the spindle 5 will be increased. If the rotational speed is too fast, the air volume is dropped through the adjustment of the adjusting valve 21 to decrease the rotational speed of the rotor 4 and the spindle 5. When making an adjustment of the air volume, the user may observe the display board 621 until the reading reaches a desired figure.

The counter module 6 is secured in the trough 55 with the second fastener 64. The sensor 61 is inserted through the aperture 56 and located in the sleeve 52, and the display board 621 of the display 62 is exposed on the sleeve 52 for the user to observe the reading easily. It is easy to dismount the counter module 6 from the trough 55 of the sleeve 52 for maintenance.

What is claimed is:

1. A pneumatic tool having a rotational speed detection device, comprising:
a main body having a first chamber and a second chamber therein;
an air flow control module inserted into the second chamber of the main body;
a rotor disposed in the first chamber of the main body;
a spindle having a first end connected to the rotor and a second end connected to a connector, the spindle being covered with a sleeve, the sleeve being secured to the main body, and characterized by:
the spindle comprising a light blocking member thereon, the sleeve comprising a sensor corresponding in position to the light blocking member, a counter module and a display, the sensor being electrically connected to the counter module, the display being adapted to show a rotational speed.

2. The pneumatic tool having a rotational speed detection device, as claimed in claim 1, wherein the main body further comprises a partition between the first chamber and the second chamber and an intake sleeve, the partition being formed with a through hole for interconnecting the first chamber with the second chamber, the intake sleeve being inserted into the second chamber, the rotor being disposed in the first chamber, the air flow control module being inserted into the second chamber and located between the partition and the intake sleeve.

3. The pneumatic tool having a rotational speed detection device, as claimed in claim 2, wherein the air flow control module comprises an adjusting valve and an intake valve, the adjusting valve and the intake valve being inserted into the second chamber from respective sides of the main body and located between the partition and the intake sleeve.

4. The pneumatic tool having a rotational speed detection device, as claimed in claim 3, further comprising an initiating element, the initiating element being pivotally connected to an outer wall of the main body at an angle and holding against the intake valve of the air flow control module.

5. The pneumatic tool having a rotational speed detection device, as claimed in claim 1, wherein the rotor comprises at least a driven member on a side wall thereof.

6. The pneumatic tool having a rotational speed detection device, as claimed in claim 1, wherein the sleeve has a first end secured to the main body with a first fastener and a second end provided with a lid, the connector extending out the lid, the sleeve further having a trough on an outer wall thereof and an aperture in the trough, the counter module being secured in the trough with a second fastener, the sensor being inserted through the aperture and located in the sleeve, the display being exposed on the sleeve.

7. The pneumatic tool having a rotational speed detection device, as claimed in claim 6, wherein the sleeve comprises a first connecting portion and a second connecting portion, the first connecting portion and the second connecting portion being secured together with a third fastener, the trough being disposed on the first connecting portion.

8. The pneumatic tool having a rotational speed detection device, as claimed in claim 1, wherein the display comprises a display board, a switch, and a protecting lid, the display board and the switch being electrically connected to the counter module, the protecting lid being adapted to cover the counter module.

9. The pneumatic tool having a rotational speed detection device, as claimed in claim 1, wherein the connector comprises a clip and a fixture, the clip being inserted into the spindle, the fixture being fitted onto the clip and secured to the spindle.

10. The pneumatic tool having a rotational speed detection device, as claimed in claim 1, wherein the sensor is in a reverse U-like shape and the light blocking member is in a circular shape with at least a light blocking tab extending from a rim thereof.

11. The pneumatic tool having a rotational speed detection device, as claimed in claim 1, wherein the spindle has a blocking portion corresponding in position to the sensor, the light blocking member having a first side holding against the blocking portion, the spindle further comprising a locating ring holding against a second side of the light blocking member.

12. The pneumatic tool having a rotational speed detection device, as claimed in claim 11, wherein the locating device is a C-shaped ring.
